(19) United States
(12) Patent Application Publication
(10) Pub. No.: US 2022/0272939 A1
(43) Pub. Date: Sep. 1, 2022

(54) Reversible Sliding-Handle Drive Assembly for a Livestock Head Gate

(71) Applicant: Northquip Inc., Woodlands (CA)

(72) Inventors: Stephen Arthur Langrell, Woodlands (CA); Philip Malcolm Firth, Woodlands (CA)

(21) Appl. No.: 17/629,577

(22) PCT Filed: Nov. 19, 2019
(86) PCT No.: PCT/CA2019/051646

§ 371 Date: Jan. 24, 2022

(51) Int. Cl. A01K 1/06

(52) U.S. Cl. CPC A01K 1/0613

(57) ABSTRACT

A head gate drive assembly for a livestock chute features a rectangular longitudinal shaft at a first side of the chute, a handle slidable along the shaft and operable to rotate same, and a control arm coupled to the shaft at the front of the chute to operate the head gate. The arm and shaft are directly coupled in a fastener-free removable manner enabling remounting of the arm in a reversed orientation for use at an opposing second side of the chute. Front and rear support assemblies for the shaft are removably mounted at first predefined mounting locations on the first side of the chute, which are mirrored by a second set of predefined mounting locations on the second side of the chute. The front support assembly features bushings of circular outer profile rotatable inside a housing, and of rectangular inner profile conforming to the shaft passing through said housing.

### FIELD OF THE INVENTION

The present invention relates generally to livestock handling equipment, and more particularly to a livestock chute with a head gate operable from various locations along the chute via an operating handle that slidably mounted on a rotatable overhead shaft running longitudinally of the chute.

### BACKGROUND

Applicant's commercialized Q-Catch 86 Series Squeeze Chute is of the aforementioned type, where on side of the chute, an elongated shaft made of rectangular metal tubing is rotatably supported in an elevated overhead position running longitudinally of the chute between the front head-gate equipped exit thereof and the rear slide-gate equipped entrance thereof. An operating handle is slidable back and forth along this shaft, and is operable to drive rotation of the shaft about its longitudinal axis. At the front end of the chute, the elongated rectangular shaft is indirectly coupled to a control arm of a head gate operating linkage by which two movable gate panels of the head gate are movable toward one another to close the head gate, and away from one another to open the head gate. This indirect coupling of the rectangular elongated shaft to the control arm is achieved by bolted connection of a proximal end of the elongated rectangular shaft to a short round stub-shaft that is journaled inside an upright support tower welded to the framework of the chute at position standing upright from a front end cross-header that hosts the transverse shaft on which the gate panels are rollably supported. The front end of this stub shaft is in turn welded to the control arm of the head gate operating linkage, from which two link arms connect respectively to the gate panels to control movement and unlocking thereof. Accordingly, rotation of the elongated rectangular shaft via the slidable handle rotates the round stub shaft, thereby pivoting the control arm to actuate the linkage and operate the head gate. The slidable nature of the operating handle allows the user to operate the head gate from any number of longitudinally variable locations along the chute.

While the existing product can be manufactured in either a right-hand or left-hand configuration, i.e. with the elongated shaft, operating handle and control arm on either side of the chute, the chute is not subsequently reconfigurable to the opposite handed configuration once manufactured. Accordingly, conventional approach has been to typically manufacture standardized chutes that all have their head gate control on a same predetermined side of the chute, and to only manufacture customized chutes with the other-handed configuration when specifically requested in advance by a customer.

It would desirable to provide a more flexible approach for users who may prefer operation from one side over another, and to accommodate environmental constraints that may limit the accessibility of one side of the chute versus another in a particular application. Furthermore, the used of bolted connections between the rectangular handle-supporting rectangular shaft and the round arm-driving stub shaft also leaves room for improvement, as fastener-based connections among moving drive components can lead to premature wear, unexpected breakage, and loosened connections introducing undesirable play between such parts.

Accordingly, there remains room for improvement to head gate drive assemblies of the forgoing type.

### SUMMARY OF THE INVENTION

According to a first aspect of the invention, there is provided, in a livestock chute comprising a framework delimiting an interior space of the chute through which animals traverse on a longitudinal pathway from an entrance opening at a rear end of said chute to an exit opening at a longitudinally opposing front end of said chute, and a head gate operably installed at said exit opening to enable securement of an animal at said exit opening, a drive assembly installed on said framework and co-operably coupled to said head gate to drive operation thereof between open and closed positions, said drive assembly comprising:

an elongated shaft lying externally and longitudinally of the chute at a first side thereof in an elevated position in which said elongated shaft is rotatable about a longitudinal axis thereof, said elongated shaft having a proximal end residing adjacent the front end of the chute and a longitudinally opposing distal end residing adjacent the rear end of the chute;

a handle coupled to said elongated shaft in a manner that is rotationally locked thereto to enable rotation of said elongated shaft via manipulation of said handle, but is repositionable longitudinally along said elongated shaft to enable operation of said handle from longitudinally distinct locations along the chute; and

an operating linkage co-operably installed between said elongated shaft and two movable gate panels of said head gate to operate said head gate between the open and closed positions by movement of said gate panels, said operating linkage comprising a control arm coupled to the elongated shaft at or adjacent the proximal end thereof for rotation therewith about said longitudinal axis;

wherein said elongated shaft is directly coupled to said control arm of the linkage.

According to a second aspect of the invention, there is provided, in the same type of livestock squeeze chute recited in the preamble of the first aspect of the invention, a drive assembly installed on said framework and co-operably coupled to said head gate to drive operation thereof between open and closed positions, said drive assembly comprising:

an elongated shaft lying externally and longitudinally of the chute at a first side thereof in an elevated position in which said elongated shaft is rotatable about a longitudinal axis thereof, said elongated shaft having a proximal end residing adjacent the front end of the chute and a longitudinally opposing distal end residing adjacent the rear end of the chute;

a handle coupled to said elongated shaft in a manner that is rotationally locked thereto to enable rotation of said elongated shaft via manipulation of said handle, but is repositionable longitudinally along said elongated shaft to enable operation of said handle from longitudinally distinct locations along the chute; and

an operating linkage co-operably installed between said elongated shaft and two movable gate panels of said head gate to operate said head gate between the open and closed positions by movement of said gate panels, said operating linkage comprising a control arm coupled to the elongated shaft at or adjacent the proximal end thereof for rotation therewith about said longitudinal axis;

wherein said elongated shaft is rotatably supported, at least in part, by at least one outer bushing through which the elongated shaft extends, each outer bushing having a non-circular internal profile of conforming shape to said elongated shaft, and a circular outer profile around which said bushing is rotatably contained in a housing mounted to the framework of the chute.

According to a third aspect of the invention, there is provided, in the same type of livestock squeeze chute recited in the preamble of the first aspect of the invention, a drive assembly installed on said framework and co-operably coupled to said head gate to drive operation thereof between open and closed positions, said drive assembly comprising:

an elongated shaft lying externally and longitudinally of the chute at a first side thereof in an elevated position in which said elongated shaft is rotatable about a longitudinal axis thereof, said elongated shaft having a proximal end residing adjacent the front end of the chute and a longitudinally opposing distal end residing adjacent the rear end of the chute;

a handle coupled to said elongated shaft in a manner that is rotationally locked thereto to enable rotation of said elongated shaft via manipulation of said handle, but is repositionable longitudinally along said elongated shaft to enable operation of said handle from longitudinally distinct locations along the chute;

an operating linkage cooperably installed between said elongated shaft and two movable gate panels of said head gate to operate said head gate between the open and closed positions by movement of said gate panels, said operating linkage comprising a control arm coupled to the elongated shaft at or adjacent the proximal end thereof for rotation therewith about said longitudinal axis of the elongated;

a front support assembly rotatably supporting the elongated shaft at a location nearer to the proximal end thereof than to the distal end thereof; and

a rear support assembly rotatably supporting the elongated shaft at a location nearer to the distal end thereof than to the proximal end thereof;

wherein the control arm of the linkage and the elongated shaft are configured to enable removal of the control arm from the elongated shaft and remounting of said control arm back onto the elongated shaft in a reversed orientation thereon to accommodate relocation of said elongated supported shaft from the first side of the chute to an opposing second side thereof to enable user reconfiguration of the chute for control of the head gate from a user-selected side thereof.

### BRIEF DESCRIPTION OF THE DRAWINGS

One embodiment of the invention will now be described in conjunction with the accompanying drawings in which:

FIG. 1 is a front perspective view of a livestock squeeze chute with a head gate drive assembly according to the present invention.

FIG. 2 is another front perspective view of the chute of FIG. 1 with a sign plate there removed to reveal details of an operating linkage of the control gate.

FIG. 3 is another front perspective view of the chute of FIG. 2 from an opposing side thereof.

FIG. 4 is an enlarged partial front perspective view of the chute of FIG. 3.

FIG. 5 shows the chute of FIG. 4 with link arms of the operating linkage removed in a first step of disassembly of the head gate drive assembly to enable relocation from its currently mounted side of the chute to an opposing side thereof.

FIG. 6 shows the chute of FIG. 5 after subsequent removal of a control arm of the operating linkage from a primary elongated shaft of the drive assembly in a second step of said disassembly.

FIG. 7 shows the chute of FIG. 6 after full removal of the entire drive assembly from the chute.

FIG. 8 shows the removed drive assembly in isolation from the chute.

FIG. 9 is an exploded partial view of the removed drive assembly of FIG. 8, showing front support components thereof together with the previously control arm.

FIG. 10 is an exploded partial view of the removed drive assembly of FIG. 8, illustrating assembly of rear support components thereof.

FIG. 11 is another exploded partial view of the removed drive assembly and control arm of FIG. 9, but with the control arm, operating handle and a front support housing having been repositioned in reverse orientations from those shown in FIG. 9, thereby preparing the drive assembly for remounting at the second side of the chute.

FIG. 12 is another exploded partial view of the removed drive assembly of FIG. 11, illustrating reorientation and re-assembly of rear support components thereof.

FIG. 13 illustrates the reconfigured drive assembly having been reassembled from the reversed components of FIG. 10, and therefore ready for re-mounting on the second side of the chute.

### DETAILED DESCRIPTION

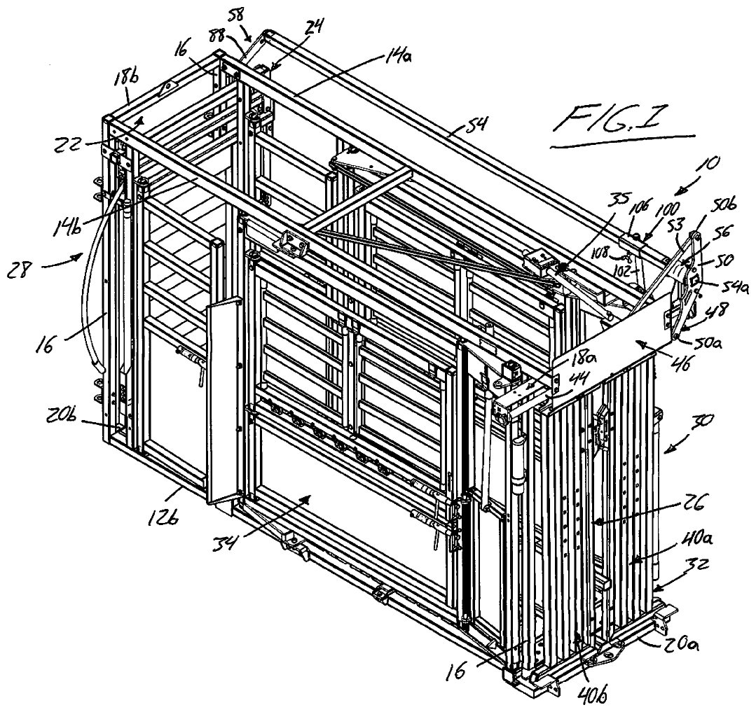

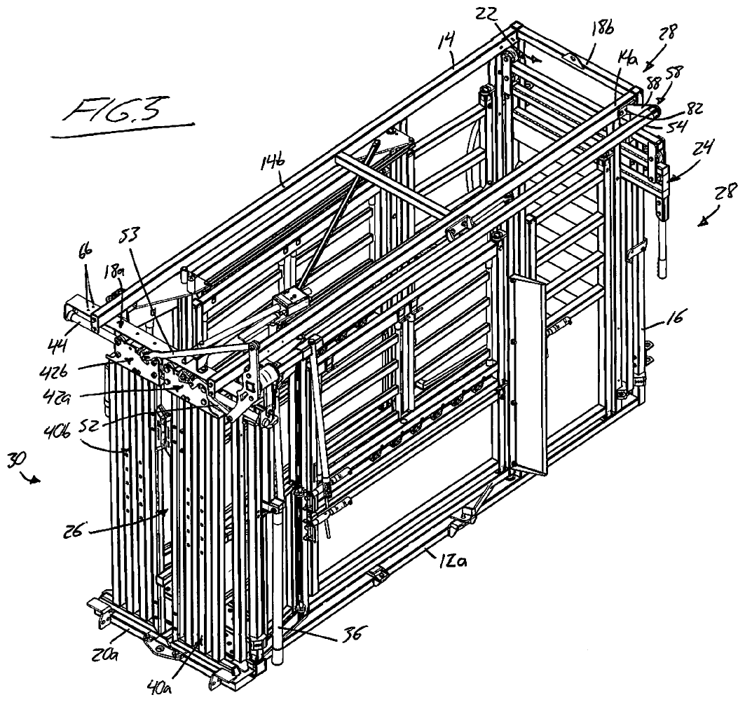

With initial reference to FIGS. 1 to 3, there is shown a livestock squeeze chute 10 according to one embodiment of the present invention. The chute 10 features a framework that delimits an interior space of the chute, and also an entrance and exit thereto and therefrom. In addition to forming this skeletal structure of the chute, the framework also serves to support all of the functional components of the chute. The framework includes a pair of longitudinal floor beams 12a, 12b lying horizontally in a longitudinal direction of the chute, a pair of longitudinal header beams 14a, 14b lying horizontally in parallel relation to the floor beams 12 in elevated relation thereover at a top header of the chute, and a set of corners posts 16 each standing vertically upright from one of the floor beams 12 at an end thereof to perpendicularly interconnect same to the matching end of one of the longitudinal header beams 14. The framework thus delimits an interior space of generally rectangular volume. At each end of the chute, the two respective corner 16 posts are perpendicularly connected at their top ends by a respective cross-header 18a, 18b that spans horizontally therebetween, and are likewise perpendicularly and horizontally connected at their bottom ends by a respective cross-sill 20a, 20b. At each end of the chute, the two corners posts 16, cross-header 18a, 18b and cross-sill 20a, 20b collectively denote a border frame around a respective rectangular opening through which entrance and exit to and from the chute's interior space is possible, thereby enabling traversal of an animal through said interior space from one opening to the other on a longitudinal pathway therebetween.

The border-framed opening at a first of these two ends of the chute is referred to herein as an entrance opening 22 through animals are admitted into the interior space in controlled one-by-one fashion via a sliding gate 24 installed in this entrance opening 22. The border-framed opening at the opposing second end chute is referred to herein as an exit opening 26 through which animals depart the interior space of the chute once having travelled therethrough on the longitudinal path from the opposing entrance opening 22. The first and second ends of the chute are thus also referred to as the rear and front ends 28, 30 of the chute, respectively, in relation to the travel direction in which animals move therethrough, travelling forwardly from the rear end of the chute toward the opposing front end thereof. Departure of the individually admitted animal from the chute through the exit opening at the front end 30 thereof is controlled via a head gate 32, closing of which is performed while the animal attempts to pass through the exit opening 26 so that two movable gate panels of the head gate abut against opposing sides of the animal's body to help hold the animal in a position in which their head resides outside the chute, while the trailing remainder of their body is still inside the chute.

To further hold the animal stationary in this position, the chute 10 also features a pair of movable side walls 34, each normally residing in a non-working position situated generally within a vertical plane bound by the longitudinal floor beam 12a, 12b, the corresponding longitudinal header beam 14a, 14b and the corresponding two corner posts 16 at a respective side of the chute. Via a control linkage 35, for example operable by a squeeze control lever 36 installed externally on one side of the chute near the head gate 32 and exit opening 26, the two side walls 34 are selectively movable in an inward direction toward one another and into the interior space of the squeeze chute in order to constrict the width of the interior space and thereby squeeze against opposing sides of the trailing rear portion of the animal's body inside the chute. This cooperates with the head gate 32 to further constrain the animal in a stationary position for safe inspection and/or treatment thereof by a human operator from laterally outside the chute.

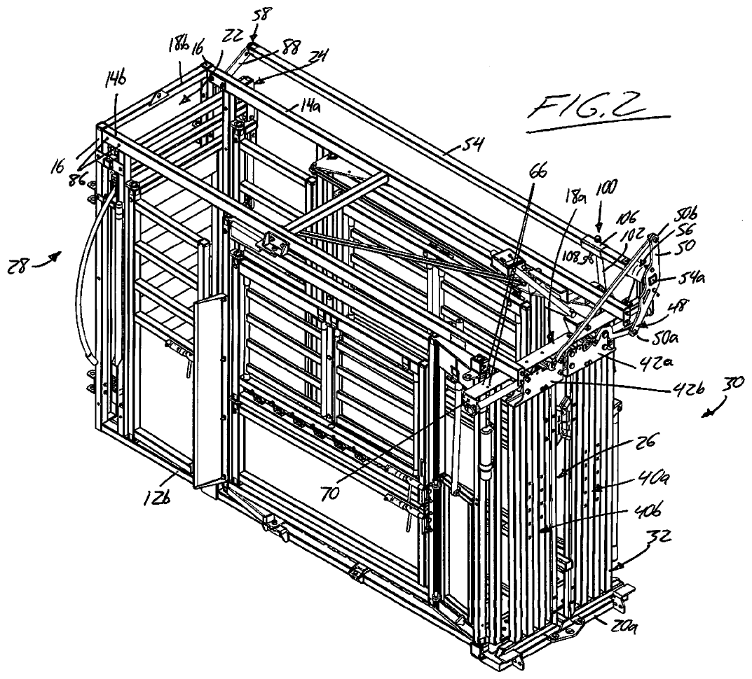

The head gate 32 features two movable gate panels 40a, 40b each suspended from a respective carriage 42 having a set of rollers therein that ride on a transverse shaft 44 of the head gate 32. This transverse shaft 44 is mounted to the cross-header 18a of the exit opening 26, and thus lies perpendicularly transverse to the chute's longitudinal direction so that the two movable gate panels 40a, 40b can slide laterally toward and away from another in this transverse direction via rolling movement of their carriages 42a, 42b on the transverse shaft. The carriages 42a, 42b also have spring loaded locking mechanisms therein that normally bite onto the shaft 44 to lock the gate panels against movement in the opening direction, until released through user input provided via the drive mechanism of the present invention via an operating linkage that connects that drive mechanism to the carriages 42a, 42b of the two gate panels 40a, 40b. In the illustrated chute design, the carriages 42 of the gate panels are normally obscured by a sign plate 46 mounted to the front ends of the longitudinal header beams 14a, 14b, and so the sign plate is omitted in FIG. 2 onward for illustrative purpose.

The operating linkage 48 of the head gate 32 features a control arm 50 that serves as the input member of the linkage by which overall movement thereof is driven, a lower link arm 52 that is pivotally coupled both to a lower end 50a of the control arm 50 and to the carriage 42a of the gate panel 40a nearest to the control arm 50; and an upper link arm 53 that is pivotally coupled both to an upper end 50b of the control arm 50 and to the carriage 42b of the gate panel 40b furthest from the control arm 50. The control arm 50 is pivotable about an axis that lies longitudinally of the chute at an elevated location situated above both the head gate 32 and the cross-header 20a from which the gate panel's hang. This longitudinal axis L is also offset horizontally outward from the longitudinal header beam 14a on this side of the chute. The control arm 50 thus pivots in a vertical working plane lying perpendicularly transverse of the chute's longitudinal direction at the front end of the chute. In the illustrated linkage design, each link arm 52, 53 is pivotally pinned to its respective gate panel carriage 42a, 42b through an elongated slot in the link arm by which the link arm is not only pivotable, but also slidably displaceable relative to its pivot point on the carriage 42a, 42b. The distal end of each link arm near which the link arm is pivotally pinned to the carriage defines a lock release cam by which the respective spring-loaded locking mechanism of the carriage is released during a gate-opening stroke of the linkage.

So far, the description of the chute closely matches that of Applicant's commercialized Q-Catch 86 Series Squeeze Chute in order to set an example of one context in which the present invention may be employed, but attention is now turned to the novel features of the chute 10, the operating linkage 48 and the drive mechanism by which the operating linkage is driven to operate the head gate 32.

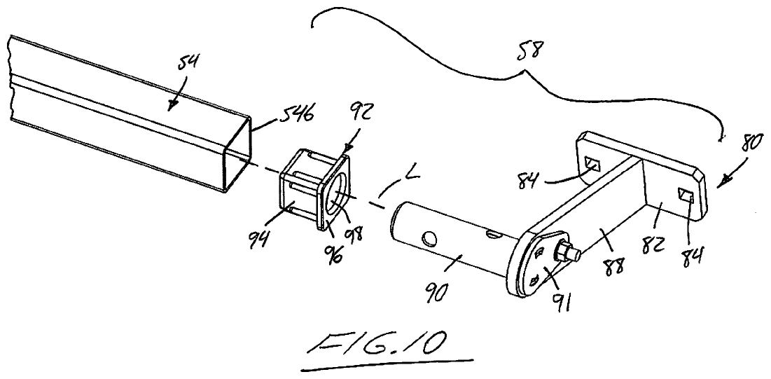

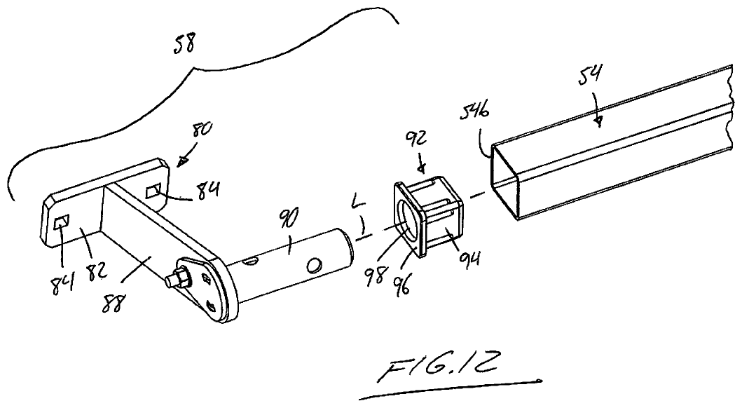

As best seen in FIGS. 9 and 11, the novel control arm 50 of the operating linkage 48 has a rectangular opening 52 therein, and more particularly a square opening in the illustrated example, the center of which corresponds the longitudinal axis L on which the control arm 50 pivots during operation of the operating linkage 48. This rectangular opening 52 is sized to accept insertion of a proximal end 54a of an elongated shaft 54 of the drive assembly, by which movement of the linkage is driven via manual user input on an operating lever slidably coupled to this elongated shaft 54. The elongated shaft 54 defines the longitudinal axis L on which the control arm 50 pivots, and is preferably formed from a length of rectangular (e.g. square) metal tubing, whereby the proximal end 54a of the elongated shaft has a suitable rectangular profile for mating cooperation with the rectangular opening 52 of the control arm 50. The rectangular opening 52 only slightly exceeds the size of the elongated shaft 54 to accommodate easy sliding of the control arm 50 onto and off of the elongated shaft 54, while the close similarity in the size of the straight-sided rectangular shape shared by the opening 52 and elongated shaft 54 prevents relative rotation between control arm 50 and the elongated shaft 54 when mated together. It will be appreciated that other profiles of non-circular shape similarly capable of preventing relation rotation between the control arm and elongated shaft may be employed as alternatives to the rectangular/square profiles of the illustrated example, whether throughout a shaft of uniform cross-sectional profile over its full length, or at least at the portion of the shaft that is received in the opening of the control arm. That being said, the rectangular/square shape of the illustrated embodiment is beneficial from the viewpoint of enabling use of economical and widely available rectangular metal tubing for the elongated shaft, as opposed to more complex or atypical shaft profiles.

The elongated shaft 54 is supported in an elevated overhead position at the same side of the chute as the control arm 50, thus spanning in parallel relation along the respective longitudinal header beam 14a of the chute framework at a short laterally offset distance and slightly elevated relation therefrom at an external location outside the chute. The elongated shaft 54 is rotatably carried in this position by a front support assembly 56 situated at or near the front end 30 of the chute, and a rear support assembly 58 situated at or near the rear end 28 of the chute.

Referring to FIG. 9, the front support assembly 56 features a support housing 60 of cylindrical shape oriented and centered on the longitudinal axis L, and an underlying mounting body 62 affixed to the support housing 60 and configured for attachment to the framework of the chute 10 at the cross-header 18a of the exit opening 26. When fastened to the cross-header 18a at a respective end thereof, the mounting body 62 holds the support housing 60 in elevated relation above this end of the cross-header 18a. In the illustrated example, the mounting body 62 features a horizontal base panel 64 for seated placement atop the cross-header 18a of the exit opening 26 and for removable bolted fastening thereto through an upper set of fastening holes 66 penetrating vertically through a horizontal top wall of the cross-header 18a. In the illustrated example, the mounting body 62 also features and an additional fastening flange 68 extending downwardly from the horizontal plane of the base panel 64 at one end thereof for removable bolted connection to a vertical end wall of the cross-header 18a via an additional lower fastening hole 70 that penetrates through this end wall of the cross-header. The base panel 64 and fastening flange 68 of the mounting body 62 feature predefined fastening apertures therein for alignment with the predefined fastening holes 66, 70 in the cross-header 18a of the chute.

The front support assembly 56 also features a pair of bushings 72a, 72b that fit externally over the elongated shaft 54, and are thus referred to herein as outer bushings 72a, 72b to distinguish them over a different style of “inner bushing” that is used at the rear support assembly 58 and fits internally within the hollow elongated shaft 54 at the opposing distal end 54b thereof, as described in more detail further below. Each outer bushing 72a, 72b is externally cylindrical over a substantial majority of its axial length, whereby this cylindrical portion 74 provides the outer bushing with a circular outer profile sized to fit within the cylindrical interior of the support housing 60 in a rotatable manner therein. One end of each outer bushing 72a, 72b is a flanged end 76 that is of greater diameter than the cylindrical remainder of the bushing, and also of greater diameter than the cylindrical interior of the support housing 60. The cylindrical portion 74 of each outer bushing 72a, 72b is inserted into the support housing 60 from a respective end thereof until the larger flanged end 76 of the outer bushing abuts against the respective end of the housing, thereby defining the bushing's fully inserted position. The combined axial length of the cylindrical portions 74 of the two outer bushings 72a, 72b is less than the full axial length of the cylindrical support housing 60, thereby enabling full insertion of both bushings from the axially opposing ends of the support housing 60 without interference with one another.

An internal profile of each outer bushing 72a, 72b is not cylindrical like the majority of its outer profile. Instead, each outer bushing 72a, 72b has a rectangular inner profile 78 sized to enable passage of the rectangular elongated shaft 54 therethrough. This enables sliding the outer bushings 72a, 72b onto the elongated shaft 54 in a shape-conforming manner preventing relative rotation between the outer bushings 72a, 72b and the elongated shaft 54 due to their matching non-circular profiles. Accordingly, with the outer bushings 72a, 72b fitted over the elongated shaft 54 received inside the support housing 60, the elongated shaft 54 passes axially through the support housing 60 and is rotatably supported therein for rotation about the longitudinal axis L that is shared by the elongated shaft 54, the outer bushings 72a, 72b, the support housing 60 and the control arm 50.

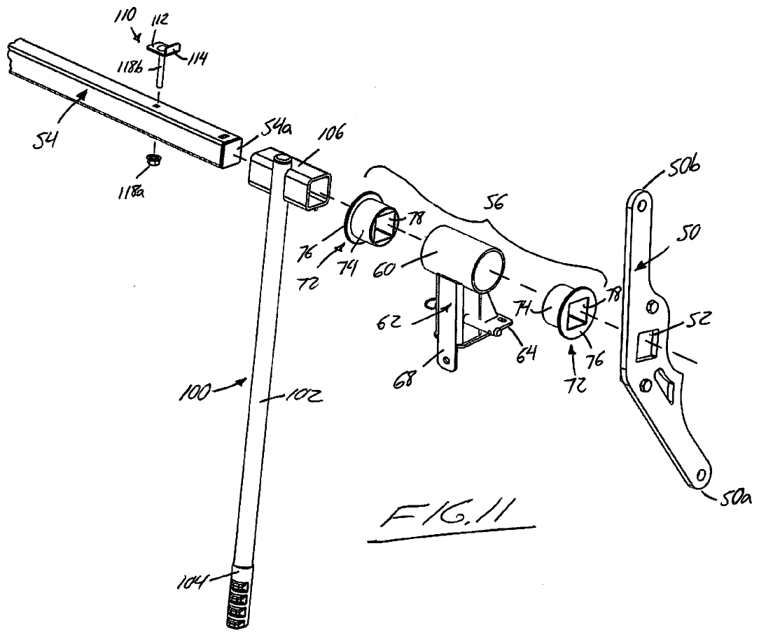

Referring to FIG. 10, the rear support assembly 58 features a support bracket 80 having a mounting plate 82 for placement in abutting relation against an outer side of the respective longitudinal header beam 14a of the chute's framework, particularly at predefined mounting location near the rear end 28 of the chute 10. Here, a set of fastener apertures 84 in the mounting plate 82 align with a set of predefined fastening holes 86 that penetrate horizontally through the longitudinal header beam 14a to define the prescribed mounting location thereon. The support bracket 80 also has a support arm 88 that cantilevers outwardly from the mounting plate 82 to one side thereof in an inclined fashion. The support arm 88 carries a stub shaft 90 at a spaced distance and elevated relation from the mounting plate 82 of the bracket 80 and the header beam 14a to which the bracket 80 is fastened.

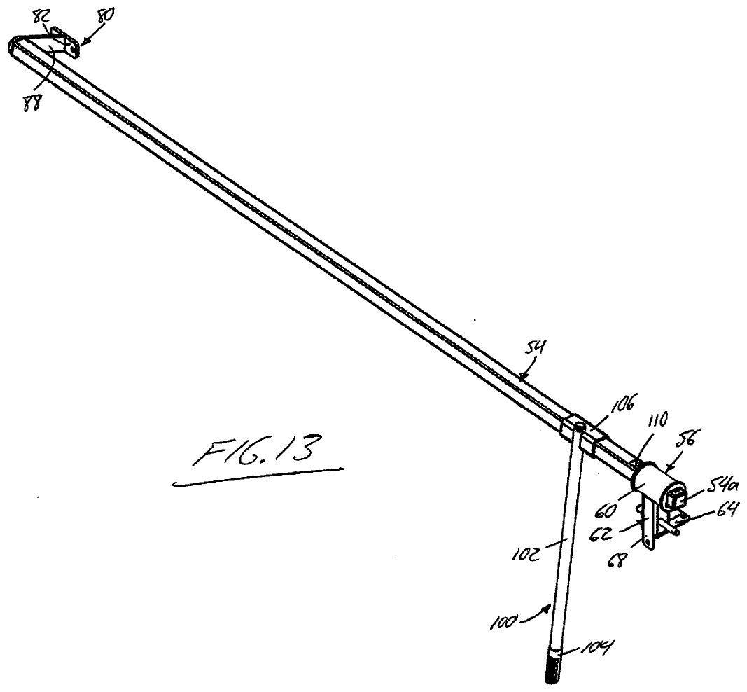

The stub shaft 90 is removably coupled to the support arm 88 by way of a backing plate 91 to which the stub attached is affixed, and which is removably bolted to a side of the support arm 88 opposite that from which the stub shaft projects via a through-hole in the support arm 88 near the free end thereof opposite the mounting plate 82. The support bracket and thus be reconfigured by unfastening the backing plate 91, puling the backing plate 91 from the support arm 88 to withdraw the stub shaft from the through-hole of the support arm, and then reinserting the stub shaft from the opposite side of the support arm 88, and refastening the backing plate 91 to this opposite side of the support arm. This changes the particular side of the support arm 88 from which the stub shaft 90 projects, thus reversing the working orientation the support bracket, as can be seen by comparison of FIGS. 10 and 12.

In the installed position of the support bracket 80 on the header beam 14a of the chute 10, the stub shaft 90 reaches longitudinally forward from a front side of the support arm 88, thus extending toward the front end 30 of the chute 20 on the same longitudinal axis L on which the support housing 60 of the front support assembly 56 resides. An inner bushing 92 of the rear support assembly 58 has a rectangular (e.g. square) outer profile over a substantial majority of its axial length, whereby this rectangular portion 94 provides the inner bushing 92 with a rectangular outer profile sized to fit in mated non-rotatable fashion within the hollow rectangular interior of the elongated shaft 54. One end of the inner bushing 92 is a flanged end 96 of increased external measure relative to the externally rectangular portion 94 of the inner bushing, and so the rectangular portion 94 of the inner bushing 92 is inserted into the hollow distal end 54b of the elongated shaft 54 until the larger flanged end 96 of the bushing abuts against this end of the elongated shaft 54, thereby defining the inner bushing's fully inserted position.

An internal profile of the inner bushing 92 is not rectangular like the majority of its outer profile. Instead, the inner bushing has a circular internal profile 98 sized to enable insertion of the stub shaft 90 axially through inner bushing 92. Accordingly, with the inner bushing 92 fitted inside the elongated shaft 54 and slid onto the stub shaft 90 of the rear support bracket 80, the elongated shaft 54 is rotatably supported on the stub shaft 90 for rotation about the longitudinal axis L shared by the elongated shaft 54, the inner bushing 92, the stub shaft 90, the support housing 60, the outer bushings 72a, 72b and the control arm 50.

In addition to the elongated shaft 54 and front and rear support assemblies 56, 58, the drive assembly further includes an operator handle 100 having an elongated shank 102, a hand grip 104 at an actuation end of the shank, and a support channel 106 affixed to an opposing working end of the shank 102. This support channel 106 is made of a short length of metal rectangular (e.g. square) tubing of matching shape but slightly greater cross-sectional size than that of the elongated shaft 54. The support channel 106 therefore fits over the elongated shaft 54 to suspend the operator handle 100 therefrom, yet is slidable back and forth along the elongated shaft to enable longitudinal repositioning of the operator handle 100 therealong. A locking mechanism may optionally be included to enable selective locking of the operator handle 100 at a user-selected position on the elongated shaft 54, for example using a wing-bolt 108 engaged in a threaded bore penetrating into the interior of the support channel 106, as can be seen in FIGS. 1 and 2.

While the operator handle 100 is longitudinally slidable on the elongated shaft 54, it is rotationally locked thereto by the similarly sized and straight-sided rectangular profiles of the support channel's interior and the elongated shaft's exterior. Accordingly, rotation of the elongated shaft 54 about its longitudinal axis L is performed via manual gripping of the operator handle 100, and swinging thereof about the longitudinal axis L. Swinging of the operator handle in a downward direction drives closure of the head gate 32 via pivoting of the control arm 50 in a closing direction that swings its lower end 50a inwardly toward the chute and its upper end 50b outwardly away from the chute, thus pushing the nearest gate panel 40a away from the longitudinal pivot axis L of the control arm, and pulling the furthest gate panel 40b toward the longitudinal pivot axis L of the control arm. Swinging of the operator handle 100 in an upward direction drives opening of the head gate via pivoting of the control arm 50 in an opening direction that swings its lower end 50a outwardly away the chute and its upper end 50b inwardly toward the chute, thus pulling the nearest gate panel 40a toward the longitudinal pivot axis L of the control arm, and pushing the furthest gate 40b away from the longitudinal pivot axis L of the control arm, during which the camming action of the link arms 52, 53 releases the locking mechanisms of the gate panel carriages 42a, 42b.

Having described the main componentry of the drive mechanism, attention is now turned to assembly and disassembly thereof, and selection between one assembled configuration intended for removable installation on one side the chute, and another assembled configuration for removable installation on the other side of the chute. This way, the particular option best suited to a particular consumer's need, particular user's preference, or particular application requirement, is easily attainable at the time of factory assembly or on-site assembly, and changeable at any time subsequent thereto should the requirements change, whether due to change of user, change in the environment of use, or change in ownership of the chute.

FIGS. 9 and 10 illustrate configuration of the drive assembly for installation on the left side of the chute, as shown in the illustrated chute of FIGS. 1 to 3. Here, the “left side” of the chute refers to that found on one's left hand side as they traverse longitudinally through the chute from the entrance opening 22 at the rear end of the chute to the exit opening 26 at the front end of the chute. That is, the terms “left side” and “right side” are used in relation to the direction in which an animal faces and travels during use of the chute 10. Installation of the drive assembly on the left side of the chute may be referred to as a right-handed installation, since a user standing beside and facing toward the head gate on this left side of the chute would operate the handle 100 of the drive assembly with their right hand. Likewise, Installation of the drive assembly on the right side of the chute may be referred to as a left-handed installation, since a user standing beside and facing toward the head gate on this right side of the chute would operate the handle 100 of the drive assembly with their left hand. It will be appreciated that this particular operation of the handle from beside the head gate is purely for the purpose of establishing this naming convention for the two different installation options, since the slidability of the operator handle 100 along the elongated shaft 54 enables operation of the head gate from anywhere along the selected side on which the drive assembly was installed. The term “operational side” is used to denote whichever side of the chute the drive assembly has been installed on in any given example.

Referring to FIG. 9, in assembling the drive assembly, the support channel 106 of the operator handle 100 is slid onto the elongates shaft 54 from either the proximal or distal end 54a, 54b thereof. The orientation in which the support channel 106 is slid onto the elongated shaft 54 is selected such that, in the fully closed condition of the head gate, the shank 102 will hang downwardly from the elongated shaft 54 at the outer side thereof that faces away from the chute when installed thereon. After installation of the handle 100, or optionally therebefore if the handle was installed from the distal end 54b of the elongated shaft 54, a stopper 110 is installed on the elongated shaft 54 at a predetermined location situated near, but longitudinally spaced from, the proximal end 54a of the elongated shaft. The stopper 110 in the illustrated example is a small L-shaped plate having a horizontal base leg 112 for flush placement on a flat side of the rectangular elongated shaft 54, and a blocking leg 114 projecting perpendicularly from the base leg 112 at an end thereof nearest the proximal end 54a of the elongated shaft 54. The base leg 112 has a fastening aperture therein for alignment with a predefined fastening hole 116 that penetrates through two opposing sides of the elongated shaft 54. This defines a predetermined mounting point on the elongated shaft 54 at which the stopper 110 is mounted by mating of a nut and bolt fastener 118a, 118b through the fastening hole 116 the aligned fastening aperture in the base leg 112 of the stopper 110.

With the stopper 110 in place, the front support assembly 56 can then be installed on the elongated shaft 54, first by sliding a first one of the two outer bushings 72a onto the elongated shaft 54 at the proximal end 54a thereof in flanged-end-first orientation. This first outer bearing 72a is slid onward until its flanged end 76 abuts against the blocking leg 114 of the stopper 110, which therefore stops further sliding of the first outer bushing 72a and defines the properly installed position thereof on the elongated shaft 54. The support housing 60 is also slid onto the elongated shaft 54 from the proximal end 54a thereof, particularly in an orientation in which its fastening flange 68 hangs downward at the outer side of the elongated shaft 54. The support housing 60 is slid into its properly installed position receiving the cylindrical portion 74 of the first outer bushing 72a so that the flanged end 76 of the first outer bushing 72a resides between the blocking leg 114 of the stopper 110 and the nearest annular end of the support housing 60. Accordingly, the stopper 110 serves to prevent or limit relative sliding between the elongated shaft 54 and both the first outer bushing 72a and the surrounding support housing 60 in a direction moving said bushing and housing closer to the distal end 54b of the elongated shaft 54.

Next, the second outer bushing 72b is slid onto the elongated shaft 54 from the proximal end 54a thereof in a reverse orientation (flanged-end-last) to that of the first outer bushing 72a, and is slid onward until the flanged end 76 of the second outer bushing 72b reaches the nearest annular end of the support housing 60, thereby inserting the cylindrical portion 74 of the second outer bushing 72b into the support housing 60. It will be appreciated that rather than sliding the first outer bushing 72a, support housing 60 and second outer bushing 72b individually onto the elongated shaft 54, one or both of the outer bushings 72a, 72b may be pre-inserted into their respective ends of the support housing 60, and the resulting bushing/housing combination then slid onto the elongated shaft 54 from the proximal end 54a thereof. It will also be appreciated that the stopper 110 may optionally be installed on the elongated shaft after initial sliding of the some or all components 60, 72a, 72b of the front support assembly 56 onto the proximal end 54a of the elongated shaft 54.

Referring to FIG. 10, assembly of the rear support assembly 58 at the distal end 54b of the elongated shaft can be performed after installation of the operating handle 100 via the same distal end 54b of the elongated shaft, or before installation of the operating handle 100 via the proximal end 54a of the elongated shaft 54, provided that such installation of the operating handle 100 is performed before installing the front support assembly 56 and associated stopper 110. The installation of the rear support assembly 58 involves inserting the inner bushing 92 into the distal end 54b of the hollow elongated shaft 54 until the flanged end 96 of the inner bushing 92 abuts against the rectangular end face of the elongated shaft 54. The stub shaft 90 of the support bracket 80 is inserted through the hollow interior of the inner bushing 92, whether before or after insertion of the inner bushing 92 into the elongated shaft 54.

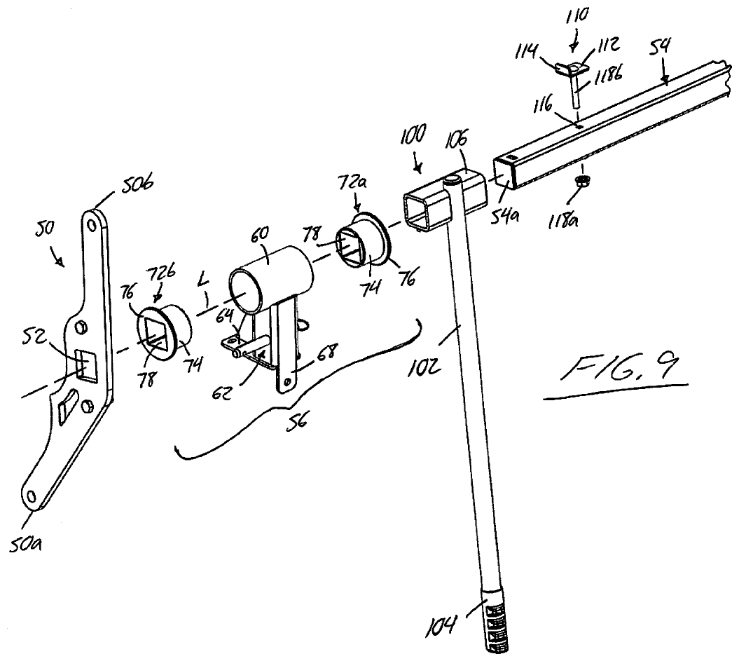

The result of the forgoing assembly steps is shown in FIG. 8, where the front and rear support assemblies 56, 58, the operating handle 100, and the stopper 110 are all installed on the elongated shaft 54, whereby this finished drive assembly is ready for mounting on the left side of the squeeze chute 10. The drive assembly is lifted up into a positioning aligning the fastening apertures in the mounting body 62 of the front support assembly 56 with the fastening holes 66, 70 provided in the cross-header 18a of the chute 10 at the left side thereof, and likewise aligning the fastening apertures 84 in the mounting plate 82 of the rear support assembly 58 with the fastening holes 86 that penetrate the longitudinal header beam 14a at the left side of the chute. The mounting body 62 of the front support assembly 56 and the mounting plate 82 of the rear support assembly are bolted in place using these aligned fastening apertures and holes, thereby supporting the elongated shaft 54 in its elevated overhead working position running externally along the left side of the chute, as shown in FIGS. 1 to 3.

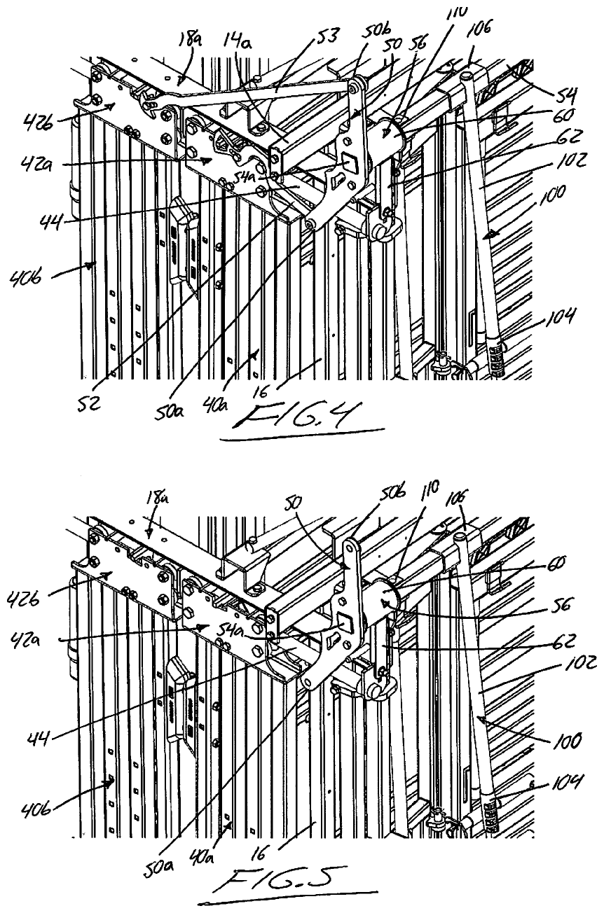

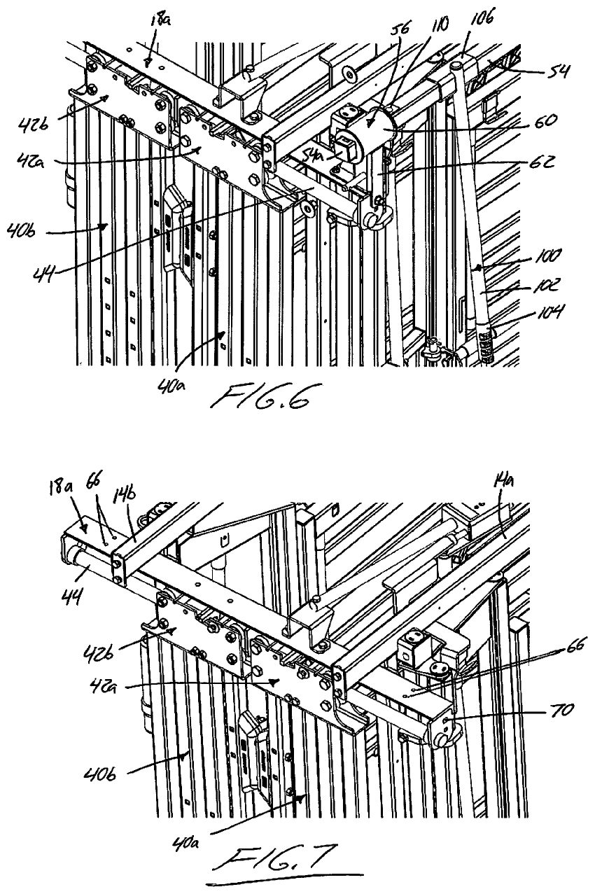

Referring again to FIG. 9, to operationally connect the installed drive assembly to the head gate 32, the control arm 50 of the head gate's operating linkage 48 is then slid onto the proximal end 54a of the elongated shaft 54 in an orientation in which a lower half of the control arm angles inwardly toward the chute 10. Such placement of the control arm 50 onto the proximal end of the elongated shaft 54 can be seen in FIG. 5. Referring to FIG. 4, the final installation step is then to connect the upper link arm 53 between the top end 50b of the control arm 50 and the furthest gate panel carriage 42b, and connect the lower link arm 52 between the bottom end 50a of the control arm and the nearest gate panel carriage 42a. The drive assembly and operating linkage 48 are thus now fully assembled in a finished right-handed installation on the left side of the chute, as shown in FIGS. 1 to 3.

The receipt of an end-adjacent portion of the elongated shaft 54 in the rectangular opening 52 of the control arm 50 serves to both couple and rotationally interlock these two components, all without engagement of any fasteners therebetween, without installation of any intermediary components therebetween, and without welded permanent attachment to one another. As can be seen in FIGS. 1 and 2, the right side of the chute 10 features identically configured sets of fastening holes 66, 70, 86 in the cross-header 18a and longitudinal header beam 14b as found on the left side of the chute. Accordingly, the chute features matching sets of predefined mounting points that reside in mirrored relation to one another on opposing sides of the chute to accommodate identical mounting of the front and rear supports 56, 58 to either selected side of the chute.

So, while FIGS. 1 to 3 show the drive assembly and operating linkage installed on the left side of the chute 10 in a right-handed configuration, removal and reconfiguration of the drive assembly and operating linkage to enable re-installation thereof at the opposing right side of the chute in a left-handed configuration is easily performed. Basically, this requires mere disconnection of the link arms 52, 53 from between the gate panel carriages 42a, 42b and control arm 50; unfastening of the drive assembly's front and rear supports 56, 58 from their currently mounted positions on the left side of the chute; removal, reversal and replacement of the various components installed on the elongated shaft 54; and refastening of the reoriented front and rear supports 56, 58 of drive assembly at the right side of the chute in mirrored relation to their original positions on the left side of the chute; and reconnection of the link arms 52, 53 of the operating linkage 48. This reconfiguration procedure is essentially the same, whether changing from left to right-handed operation, or vice versa.

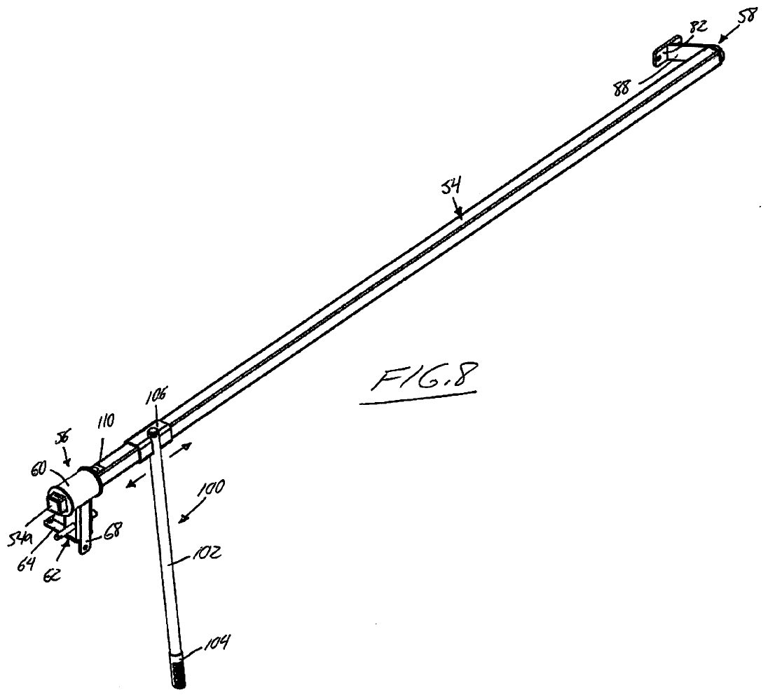

Step-by-step in more detail, the reconfiguration procedures starts with removal of the link arms 53, 54 from the operating linkage 48 (FIGS. 4-5); removal of the control arm 50 from the proximal end 54a of the elongated shaft (FIGS. 5-6); unbolting of the rear support bracket 80 and the mounting body 62 of the front support housing 60 from the chute 10, thereby releasing the entire drive assembly for removal thereof from the chute (FIGS. 7-8), whereupon the removed assembly can be lowered down to ground level or other lower elevation at which the next steps are more conveniently performed. These next steps include removal of the front support housing 60, with at least the second outer bushing 72b thereof, from the proximal end 54a of the elongated shaft 54 (FIG. 9); disengagement of the rear support bracket 80 from the distal end of the elongated shaft 54 by withdrawal of the stub shaft 90 therefrom (FIG. 11); and sliding of the operating handle 100 off the elongated shaft 54 via the distal end 54b thereof.

The drive assembly disassembled, the removed components are then reinstalled on the elongated shaft 54, but in reverse orientations to those from which they were removed. The orientation reversal of the operating handle 100, the front support housing 60 and attached mounting body 62, and the control arm 50 can be seen by comparison of FIGS. 9 and 11, and 10 and 12. The reassembly thus involves reversal of the operating handle's orientation and re-sliding thereof back onto the elongated shaft 54 at the distal end 54b thereof; removal of the stub-shaft 90 from the support arm 88 of the rear support bracket 80 and reinstallation of the stub-shaft 90 thereon in the reversed orientation thereto; re-engagement of the rear support bracket 80 to the distal end 54b of the elongated shaft 54 by reinsertion of the stub shaft 90 therein; reversal of the orientation of the removed front support housing 60 and re-sliding thereof back onto the elongated shaft 54 at the proximal end thereof 54a, optionally after first relocating the second outer bushing 72b from its original end of the support housing 60 to the other end thereof if the first outer bushing 72a wasn't also removed with the support housing 60.

With the drive assembly thus now reassembled in its right-handed configuration shown in FIG. 13, the drive assembly can be lifted up into its new intended working position at the opposing side of the chute from which it was previously removed, and bolting of the rear support bracket 80 and mounting body 62 of the front support housing 60 to said opposing side of the chute at the predefined mounting locations on the longitudinal header beam 14b and cross-header 18a; reinstalling the control arm 50 back onto the proximal end 54a of the elongated shaft in a reversed orientation from that in which it was previously removed; and connecting the upper link 53 arm between the top end 50b of the control arm 50 and the carriage 42a of the furthest gate panel 40a therefrom, and connecting the lower link arm 52 between the bottom end 50a of the control arm 50 and the carriage 42b of the nearest gate panel 40b thereto.

In an alternative embodiment, the rear support bracket 80 could have a respective stub-shaft extending from each side of the support arm, in which instance no reconfiguration of the bracket to a reversed working orientation would be required for use on one side of the chute versus the other. Similarly, while the mounting body 62 of the illustrated front support housing includes a fastening flange 68 for fastened coupling to an end-wall of the cross-header 18a of the chute's exit opening 26, which necessitates re-orientation of the support housing 60 and attached mounting body to switch the drive assembly between left and right handed installations, alternative embodiments could be configured with a particular layout of fastening points that avoid the need to reorient the support housing and its mounting body during the reconfiguration process. So the novel use of a control arm removably coupled to a bushing-supported or bearing-supported rotatable shaft in a manner enabling re-coupling of the removed control are to that shaft in a reversed orientation for use on an opposing side of the chute need not be limited to embodiments in which the supports for rotatably supporting that shaft are likewise removable and re-mountable in reversed orientations on the shaft.

Since various modifications can be made in my invention as herein above described, and many apparently widely different embodiments of same made, it is intended that all matter contained in the accompanying specification shall be interpreted as illustrative only and not in a limiting sense.

1. In a livestock chute comprising a framework delimiting an interior space of the chute through which animals traverse on a longitudinal pathway from an entrance opening at a rear end of said chute to an exit opening at a longitudinally opposing front end of said chute, and a head gate operably installed at said exit opening to enable securement of an animal at said exit opening, a drive assembly installed on said framework and co-operably coupled to said head gate to drive operation thereof between open and closed positions, said drive assembly comprising:
an elongated shaft lying externally and longitudinally of the chute at a first side thereof in an elevated position in which said elongated shaft is rotatable about a longitudinal axis thereof, said elongated shaft having a proximal end residing adjacent the front end of the chute and a longitudinally opposing distal end residing adjacent the rear end of the chute;
a handle coupled to said elongated shaft in a manner that is rotationally locked thereto to enable rotation of said elongated shaft via manipulation of said handle, but is repositionable longitudinally along said elongated shaft to enable operation of said handle from longitudinally distinct locations along the chute; and
an operating linkage co-operably installed between said elongated shaft and two movable gate panels of said head gate to operate said head gate between the open and closed positions by movement of said gate panels, said operating linkage comprising a control arm coupled to the elongated shaft at or adjacent the proximal end thereof for rotation therewith about said longitudinal axis;
wherein said elongated shaft is directly coupled to said control arm of the linkage.

2. The drive assembly of claim 1 wherein said elongated shaft is directly coupled to said control arm of the linkage by receipt of said proximal end of said elongated shaft through a cooperatively shaped opening in the control arm.

3. The drive assembly of claim 2 wherein said elongated shaft is directly coupled to said control of the linkage solely by said receipt of said proximal end of said elongated shaft through said cooperatively shaped opening in the control arm, without any additional fasteners or welded attachment therebetween.

4. The drive assembly of claim 2 or 3 wherein said cooperatively shaped opening and said elongated shaft, at least at a portion of said elongated shaft residing within said cooperatively shaped opening, are of non-circular profile to prevent relative rotation between said elongated shaft and said control arm.

5. The drive assembly of claim 4 wherein said non-circular profile is rectangular in shape.

6. The drive assembly of claim 5 wherein said elongated shaft comprises rectangular metal tubing.

7. The drive assembly of claim 1 wherein said elongated shaft is rotatably supported, at least in part, by at least one outer bushing through which the elongated shaft extends, each outer bushing having a non-circular internal profile of conforming shape to said elongated shaft, and a circular outer profile around which said bushing is rotatably contained in a housing mounted to the framework of the chute.

8. In a livestock chute comprising a framework delimiting an interior space of the chute through which animals traverse on a longitudinal pathway from an entrance opening at a rear end of said chute to an exit opening at a longitudinally opposing front end of said chute, and a head gate operably installed at said exit opening to enable securement of an animal at said exit opening, a drive assembly installed on said framework and co-operably coupled to said head gate to drive operation thereof between open and closed positions, said drive assembly comprising:
an elongated shaft lying externally and longitudinally of the chute at a first side thereof in an elevated position in which said elongated shaft is rotatable about a longitudinal axis thereof, said elongated shaft having a proximal end residing adjacent the front end of the chute and a longitudinally opposing distal end residing adjacent the rear end of the chute;
a handle coupled to said elongated shaft in a manner that is rotationally locked thereto to enable rotation of said elongated shaft via manipulation of said handle, but is repositionable longitudinally along said elongated shaft to enable operation of said handle from longitudinally distinct locations along the chute; and
an operating linkage co-operably installed between said elongated shaft and two movable gate panels of said head gate to operate said head gate between the open and closed positions by movement of said gate panels, said operating linkage comprising a control arm coupled to the elongated shaft at or adjacent the proximal end thereof for rotation therewith about said longitudinal axis;
wherein said elongated shaft is rotatably supported, at least in part, by at least one outer bushing through which the elongated shaft extends, each outer bushing having a non-circular internal profile of conforming shape to said elongated shaft, and a circular outer profile around which said bushing is rotatably contained in a housing mounted to the framework of the chute.

9. The drive assembly of claim 7 wherein said at least one outer bushing comprises two outer bushings both rotatably contained in said housing.

10. The drive assembly of claim 7 wherein said at least one outer bushing comprises a flanged outer bushing having a flanged end residing outside said housing at a respective end thereof through said bushing is received in said housing.

11. The drive assembly of claim 9 wherein each of said two outer bushings is a flanged outer bushing having a flanged end residing outside said housing at a respective end thereof through said bushing is received in said housing.

12. The drive assembly of claim 7 wherein the elongated shaft comprises a stopper mounted thereto adjacent said housing

13. The drive assembly of claim 12 wherein said stopper resides adjacent to said housing on a side thereof opposite the proximal end of the elongated shaft.

14. The drive assembly of claim 12 wherein said stopper is removably mounted to said elongated shaft.

15. The drive assembly of claim 7 wherein said housing is mounted to the framework of the chute at or adjacent the front end thereof, whereby said at least one outer bushing rotatably supports said elongates shaft at a location nearer to the proximal end thereof than to the distal end thereof.

16. The drive assembly of claim 7 wherein said housing is removably mounted to said structural framework at the first side of the chute at a first predefined mounting location on said framework, and said framework further comprises a second predefined mounting location of matching configuration on an opposing second side of the chute, thereby enabling relocation of said housing to said second opposing side of the chute to accommodate relocation of said elongated shaft, said handle and said control arm to said second opposing side the chute for operation of the head gate therefrom.

17. In a livestock chute comprising a framework delimiting an interior space of the chute through which animals traverse on a longitudinal pathway from an entrance opening at a rear end of said chute to an exit opening at a longitudinally opposing front end of said chute, and a head gate operably installed at said exit opening to enable securement of an animal at said exit opening, a drive assembly installed on said framework and co-operably coupled to said head gate to drive operation thereof between open and closed positions, said drive assembly comprising:
an elongated shaft lying externally and longitudinally of the chute at a first side thereof in an elevated position in which said elongated shaft is rotatable about a longitudinal axis thereof, said elongated shaft having a proximal end residing adjacent the front end of the chute and a longitudinally opposing distal end residing adjacent the rear end of the chute;
a handle coupled to said elongated shaft in a manner that is rotationally locked thereto to enable rotation of said elongated shaft via manipulation of said handle, but is repositionable longitudinally along said elongated shaft to enable operation of said handle from longitudinally distinct locations along the chute;
an operating linkage co-operably installed between said elongated shaft and two movable gate panels of said head gate to operate said head gate between the open and closed positions by movement of said gate panels, said operating linkage comprising a control arm coupled to the elongated shaft at or adjacent the proximal end thereof for rotation therewith about said longitudinal axis of the elongated;
a front support assembly rotatably supporting the elongated shaft at a location nearer to the proximal end thereof than to the distal end thereof; and
a rear support assembly rotatably supporting the elongated shaft at a location nearer to the distal end thereof than to the proximal end thereof;
wherein the control arm of the linkage and the elongated shaft are configured to enable removal of the control arm from the elongated shaft and remounting of said control arm back onto the elongated shaft in a reversed orientation thereon to accommodate relocation of said elongated supported shaft from the first side of the chute to an opposing second side thereof to enable user reconfiguration of the chute for control of the head gate from a user-selected side thereof.

18. The drive assembly of claim 17 wherein said elongated shaft is directly coupled to said control arm of the linkage.

19. The drive assembly of claim 17 wherein said elongated shaft is coupled to said control arm of the linkage in a fastener-free manner.

20. The drive assembly of claim 17 wherein said elongated shaft is directly coupled to said control arm of the linkage by receipt of said proximal end of said elongated shaft through a cooperatively shaped opening in the control arm.

21. The drive assembly of claim 20 wherein said cooperatively shaped opening and said elongated shaft, at least at a portion of said elongated shaft residing in said cooperatively shaped opening, are of non-circular profile to prevent relative rotation between said elongated shaft and said control arm.

22. The drive assembly of claim 21 wherein said non-circular profile is rectangular in shape.

23. The drive assembly of claim 22 wherein said elongated shaft comprises rectangular metal tubing.

24. The drive assembly of claim 17 wherein the front support assembly is removably mounted to said structural framework at the first side of the chute at a first predefined front mounting location thereon, said structural framework further comprises a second predefined front mounting location of matching configuration on the opposing second side of the chute, and the front support assembly is removable from the first predefined front mounting location and remountable in mirrored relation thereto at the second predefined front mounting location to rotatably support the elongated shaft when repositioned to said second side of the chute.

25. The drive assembly of claim 17 wherein the rear support assembly is removably mounted to said structural framework at the first side of the chute at a first predefined rear mounting location thereon, said structural framework further comprises a second predefined rear mounting location of matching configuration on the opposing second side of the chute, and the rear support assembly is removable from the first predefined rear mounting location and remountable in mirrored relation thereto at the second predefined rear mounting location to rotatably support the elongated shaft when repositioned to said second side of the chute.
